(19) United States
(12) Patent Application Publication
(10) Pub. No.: US 2010/0055346 A1
(43) Pub. Date: Mar. 4, 2010

(54) PECVD RELEASE LAYER FOR Ni TEMPLATE

(75) Inventors: Bing K. Yen, Cupertino, CA (US); Jianwei Liu, Fremont, CA (US)

Correspondence Address: Shumaker & Sieffert, P.A., 1625 Radio Drive, Suite 300, Woodbury, MN, 55125, US

(73) Assignee: SEAGATE TECHNOLOGY LLC, Scotts Valley, CA (US)

(21) Appl. No.: 12/202,554

(22) Filed: Sep. 2, 2008

(51) Int. Cl. B05D 3/10; H05H 1/24; B05D 3/04; B05D 3/12; B05C 1/00

(52) U.S. Cl. 427/569; 427/307; 427/369; 118/44

(57) ABSTRACT

The invention relates to a method of depositing a release layer on a Ni surface for use in nano-imprint lithography comprising passivating the Ni surface, etching the passivated Ni surface, and depositing a layer of fluorocarbon on the passivated and etched surface.

### BACKGROUND

Magnetic recording media are widely used in various applications, e.g., in hard disk form, particularly in the computer industry, for storage and retrieval of large amounts of data/information. These recording media are conventionally fabricated in thin film form and are generally classified as “longitudinal” or “perpendicular”, depending upon the orientation (i.e., parallel or perpendicular) of the magnetic domains of the grains of the magnetic material constituting the active magnetic recording layer, relative to the surface of the layer. FIG. 1 shows a disk recording medium and a cross section of a disk demonstrating the difference between longitudinal and perpendicular recording.

In the operation of magnetic media, the magnetic layer is locally magnetized by a write transducer or write head to record and store data/information. The write transducer creates a highly concentrated magnetic field which alternates direction based on the bits of information being stored. When the local magnetic field applied by the write transducer is greater than the coercivity of the recording medium layer, then the grains of the polycrystalline magnetic layer at that location are magnetized. The grains retain their magnetization after the magnetic field applied by the write transducer is removed. The direction of the magnetization matches the direction of the applied magnetic field. The pattern of magnetization of the recording medium can subsequently produce an electrical response in a read transducer, allowing the stored medium to be read.

In conventional hard disk drives, data is stored in terms of bits along the data tracks. In operation, the disk is rotated at a relatively high speed, and the magnetic head assembly is mounted on the end of a support or actuator arm, which radially positions the head on the disk surface. By moving the actuator arm, the magnetic head assembly is moved radially on the disk surface between tracks.

Lithographically patterned media, also known as bit-patterning, are being pursued to increase areal recording density as compared to conventional recording media. Bit-patterning combines several hundred media grains into one single magnetic island, which does not require large coercivities. The manufacturing of lithographically patterned media typically involves a nanoimprint process, i.e., the stamping of soft resist materials with hard stampers to mold a pattern within the resist. A release layer is an integral part of the nanoimprint process to facilitate the clean separation of the resist from the stamper.

Typically, the release layer is a fluoro-decyl-trichloro-silane (FDTS) self-assembled monolayer, such as perfluoro-decyl-trichloro-silane, or a liquid lubricant film, such as Z-Dol®. However, perfluoro-decyl-trichloro-silane does not adhere well to a Ni surface, and it is difficult to achieve a uniform thickness of Z-Dol® over the template surface.

Accordingly, there exists a need for an effective template release layer that can be uniformly applied to the surface of a nanoimprint stamper with good adhesion.

### SUMMARY

The invention relates to a method of depositing a release layer on a Ni surface for use in nano-imprint lithography comprising passivating the Ni surface, etching the passivated Ni surface, and depositing a layer of fluorocarbon on the passivated and etched surface.

Preferred embodiments of the invention are shown and described, by way of illustration of the best mode contemplated for carrying out the invention, in the following detailed description. As will be realized, this invention is capable of other and different embodiments, and its details are capable of modifications in various obvious respects, all without departing from the invention. Accordingly, the drawings and description are to be regarded as illustrative in nature and not as restrictive.

### BRIEF DESCRIPTION OF THE DRAWINGS

The present invention will be better understood by reference to the Detailed Description when taken together with the attached drawings, wherein:

FIG. 1 schematically shows a magnetic disk recording medium comparing longitudinal and perpendicular magnetic recording.

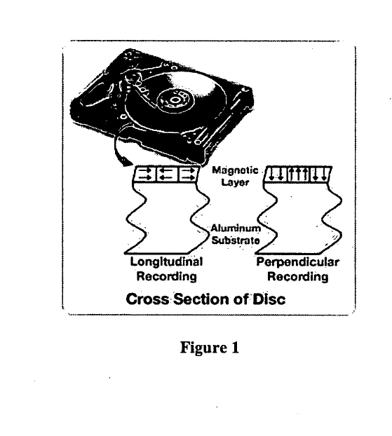

FIG. 2 shows a partial cross section of a Ni stamper having a passivated and etched surface and a fluorocarbon release layer deposited thereon.

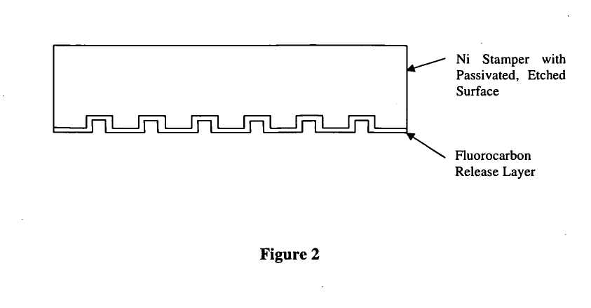

### DETAILED DESCRIPTION

One aspect of the invention is a method of depositing a release layer on a Ni surface for use in nano-imprint lithography comprising passivating the Ni surface, etching the passivated Ni surface, and depositing a layer of fluorocarbon on the passivated and etched surface. Preferably the fluorocarbon is trifluoromethane.

According to one embodiment, the step of depositing a layer of fluorocarbon comprises depositing the fluorocarbon by plasma enhanced chemical vapor deposition. In another embodiment, the step of passivating the Ni surface comprises oxidizing the Ni surface. In yet another embodiment, the step of etching the passivated Ni surface comprises exposing the Ni surface to a plasma, preferably a N₂ plasma.

According to one aspect of the invention, the release layer is a thin film layer, for example having a thickness of about 2 to about 3 nanometers.

The invention also provides a nanoimprint Ni stamper comprising a passivated and etched Ni surface and a fluorocarbon release layer deposited thereon. Further, the invention provides a method of manufacturing bit patterned media comprising coating a substrate with a photoresist layer and stamping the photoresist layer with a Ni template, wherein the Ni template comprises a passivated and etched Ni surface and a fluorocarbon release layer deposited thereon. The invention relates to a process for applying a release layer to the surface of a nanoimprint stamper that can be used in the manufacturing of patterned media. The release layer is thin layer of fluorocarbon, for example having a thickness of approximately 2-3 nm, applied to the nanoimprint stamper. In order for the fluorocarbon to adhere to the surface of the Ni stamper, the Ni surface must be pretreated as follows.

The Ni surface must be passivated, for example by oxidization. Preferably this is done by wet passivation. Following passivation, the passive Ni surface is cleaned and etched by exposed to N₂ plasma. Typically, 30 sec is sufficient to treat the passivated surface.

Once the Ni surface has been pretreated, a fluorocarbon compound is applied by plasma-enhanced chemical vapor deposition (PECVD). A preferred fluorocarbon compound is trifluoromethane.

The inventors have discovered that the pretreatment steps described above are critical to proper adhesion of the release layer on the surface of the Ni template.

### EXAMPLES

The invention will be better understood with reference to the following examples, which are intended to illustrate specific embodiments within the overall scope of the invention as claimed.

### Example 1

A Ni surface was passivated and exposed to N₂ plasma according to the present invention. A 2-3 nm fluorocarbon release layer was deposited on a Ni surface by plasma-enhanced chemical vapor deposition. The water contact angle (WCA) of the Ni surface was measured and compared with those a bare Ni surface and a surface having only the fluorocarbon layer applied without exposure to N₂ plasma. The measurements were also performed on surfaces in which the passivating step was not performed. The results are tabulated below.

Water contact angle (WCA)

| | No Passivation | Passivation |
|---|---|---|
| Reference Ni (no release layer) | Wetting | Wetting |
| Fluorocarbon deposition only | 18° | 35° |
| N₂ plasma treatment + | 105° (collapse) | 108° |
| fluorocarbon deposition | | |

As demonstrated by the results, the passivating and N₂ plasma treatments steps markedly increased the WCA of the Ni surface having a fluorocarbon release layer. Furthermore, the passivation step was necessary to prevent the water droplet from collapsing, which indicated the poor bonding between the fluorocarbon layer and the Ni surface.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

The implementations described above and other implementations are within the scope of the following claims.

What is claimed is:

1. A method of depositing a release layer on a Ni surface for nano-imprint lithography comprising passivating the Ni surface, etching the passivated Ni surface, and depositing a layer of fluorocarbon on the passivated and etched surface.

2. The method of claim 1, wherein the step of depositing a layer of fluorocarbon comprises depositing the fluorocarbon by plasma enhanced chemical vapor deposition.

3. The method of claim 1, wherein the step of passivating the Ni surface comprises oxidizing the Ni surface.

4. The method of claim 1, wherein the step of passivating the Ni surface comprises wet passivation.

5. The method of claim 1, wherein the step of etching the passivated Ni surface comprises exposing the Ni surface to a plasma.

6. The method of claim 5, wherein the plasma is a N₂ plasma.

7. The method of claim 1, wherein the fluorocarbon is trifluoromethane.

8. The method of claim 1, wherein the fluorocarbon layer has a thickness of about 2 to about 3 nanometers.

9. The method of claim 6, wherein the fluorocarbon layer has a thickness of about 2 to about 3 nanometers.

10. A nanoimprint Ni stamper comprising a passivated and etched Ni surface and a fluorocarbon release layer deposited thereon.

11. The nanoimprint Ni stamper of claim 10, wherein the release layer has a thickness of about 2 to about 3 nanometers.

12. The nanoimprint Ni stamper of claim 10, wherein the Ni surface is passivated by oxidation.

13. The nanoimprint Ni stamper of claim 10, wherein the Ni surface is etched by exposure to a plasma.

14. The nanoimprint Ni stamper of claim 13, wherein the plasma is a N₂ plasma.

15. The nanoimprint Ni stamper of claim 10, wherein the fluorocarbon is trifluoromethane.

16. A method of manufacturing bit patterned media comprising coating a substrate with a photoresist layer and stamping the photoresist layer with a Ni template, wherein the Ni template comprises a passivated and etched Ni surface and a fluorocarbon release layer deposited thereon.

17. The method of manufacturing bit patterned media of claim 16, wherein the release layer has a thickness of about 2 to about 3 nanometers.

18. The method of manufacturing bit patterned media of claim 16, wherein the Ni surface is passivated by oxidation.

19. The method of manufacturing bit patterned media of claim 16, wherein the Ni surface is etched by exposure to a N₂ plasma.

20. The method of manufacturing bit patterned media of claim 16, wherein the fluorocarbon is trifluoromethane.
